(19) United States
(12) Patent Application Publication
(10) Pub. No.: US 2013/0074361 A1
(43) Pub. Date: Mar. 28, 2013

(54) Drying Arrangement and Method for Drying a Moving Web

(71) Applicant: Metso Paper, Inc., Helsinki (FI)

(72) Inventors: Pasi Rajala, Turku (FI); Richard Solin, Turku (FI); Olli Huhtala, Merimasku (FI)

(73) Assignee: METSO PAPER, INC., Helsinki (FI)

(21) Appl. No.: 13/623,799

(22) Filed: Sep. 20, 2012

(30) Foreign Application Priority Data
Sep. 22, 2011 (FI) 20115931

(51) Int. Cl. F26B 21/06; F26B 7/00

(52) U.S. Cl. CPC F26B 21/06; F26B 7/00
USPC 34/524; 34/611; 34/443

(57) ABSTRACT

Moisture profiling is carried out in the transverse direction of a moving paper or board web. An air dryer has a first air supply channel extending transverse to the web and second air supply channels which are connected with the first air supply channel, and into which heated drying air is supplied from the first air supply channel. The second air supply channels are parallel to the travel direction of the web. The air dryer has elongated blowing members, each arranged in connection with a plurality of second air supply channels for supplying heated drying air from the second air supply channels to the blowing members. A profiling connection is arranged in connection with at least one, preferably several, second air supply channels for supplying additional air into the second air supply channel in order to change the moisture profile of the web in the transverse direction of the web.

### CROSS REFERENCES TO RELATED APPLICATIONS

This application claims priority on Finnish Application No 20115931, filed Sep. 22, 2011, the disclosure of which is incorporated by reference herein.

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

The invention relates to a drying arrangement and a method for drying a moving web, such as a paper or board web.

In the manufacture of paper and board, different dryers are used for contact-free drying of the moving web. The dried paper or the like should preferably be as evenly dried as possible, i.e. the moisture profile of the paper should be as uniform as possible. Variations in the moisture profile of the paper may impair the runnability of the paper web in finishing treatment, for example coating or calendering of the paper. Variations in the moisture profile of the paper may also cause problems in the processing of finished paper. For example as the speeds of printing machines rise higher and higher, variation in the moisture profile of the paper may cause web breaks in the printing process.

Generally infrared dryers and/or air dryers are used for drying paper webs and the like. In infrared dryers the web is dried in a contact-free manner by subjecting it to thermal radiation. Control of the moisture profile in the transverse direction of the web is often done with the aid of infrared dryers. Infrared dryers are however expensive, and thermal radiation has a tendency to “spread”, so a precisely limited profiling is difficult. Furthermore, the energy efficiency of the infrared dryers is not optimal, whereby their operation costs are high Infrared dryers also regularly require expensive maintenance operations, because in electrical infrared dryers the infrared lamps are to be changed at regular intervals and in gas infrared dryers the emitters of the dryer are to be changed typically even with 2-5 year intervals. Furthermore, the temperature of the web to be dried may easily rise too high when using an infrared dryer. Harmful combustion gases may also be generated in connection with the use of gas infrared dryers, the transfer of which gases into the machine room air should be prevented. There thus exists a need for a simple, safe and less expensive alternative, by means of which it would be possible to perform at least partial moisture profiling in the transverse direction of the web to be dried. Air dryers, for example airborne web-dryers, may also be used for drying a paper web or the like. The operation of the air dryer is based on convection, i.e. on the transfer of heat via a medium. In an air dryer heated air is blown with blow nozzles toward the surface of the web in order to dry it. Air dryers are an extremely energy efficient way of drying a moving paper web, but until now it has not been possible to use them for correcting moisture defects in the transverse direction of the web.

An object of the present invention is to reduce or even eliminate the above-mentioned problems appearing in prior art.

One object of the invention is to improve the energy efficiency of a drying section of a paper machine, and to reduce the amount of energy needed for the drying.

Another object of the invention is to provide an arrangement and method, by means of which control of the moisture profile of a moving web in the transverse direction of the web may be improved.

### SUMMARY OF THE INVENTION

A typical drying arrangement according to the invention for a moving web, such as a paper or board web, the arrangement comprising an air dryer, comprises

a first air supply channel, which defines a first direction, and which extends in a transverse direction of the web to be dried from its first edge toward its second edge,

a number of second air supply channels, which are arranged in connection with
the first air supply channel, and into which heated drying air is supplied from the first air supply channel, the second air supply channels defining a second direction, which is perpendicular to the first direction and parallel to the travel direction of the web to be dried,

elongated blowing means, each of which is arranged in connection with a plurality of second air supply channels for supplying heated drying air from the second air supply channels to the blowing means, the blowing means being parallel to the first air supply channel, whereby a profiling connection is arranged in connection with at least one, preferably several, second air supply channels for supplying additional air into the second air supply channel in order to change the moisture profile of the web in the transverse direction of the web.

A typical method according to the invention for drying a web, such as a paper or board web, comprises

supplying heated drying air into a first air supply channel, which defines a first direction, and which extends in a transverse direction of the web to be dried from its first edge toward its second edge,

leading heated air from the first air supply channel into a number of second air supply channels, which are arranged in connection with the first air supply channel, the second air supply channels defining a second direction, which is perpendicular to the first direction and parallel to the travel direction of the web to be dried,

leading heated air from the second air supply channels into elongated blowing means, each of which is arranged in connection with a plurality of second air supply channels, the blowing means being parallel to the first air supply channel, and

supplying additional air into at least one, preferably several, second air supply channels through a profiling connection or connections in order to change the moisture profile of the moving web in the transverse direction of the web.

Now it has surprisingly been realized that by arranging a profiling connection in the second air supply channel of the air dryer, which profiling connection is used for supplying additional air into the second air supply channel, an air dryer arrangement may simply and easily be created, by means of which moisture profiling in the transverse direction of the web is possible. With the aid of the additional air the temperature of the drying air may be changed in the transverse direction of the web. Depending on the temperature of the additional air, i.e. if it is warmer or colder than the actual drying air, the web may either be dried more or less in the predetermined locations in the transverse direction of the web. According to the invention the moisture profile of the web may be changed or equalized either by drying certain determined locations of the web more or less than the web in general.

It has been realized that an arrangement according to the invention may equalize in the transverse moisture profile of the web local variations, having a magnitude of even 0.5 percentages of moisture. The arrangement according to the invention is relatively simple, whereby it does not require heavy investment or maintenance costs. Furthermore, energy needed for drying and moisture profiling of the web is saved, when the moisture profiling may be carried out by using energy efficient air drying based on thermal convection. One advantage of the invention is also that the pressure in the blow members remains substantially at the same level also during profiling, whereby runnability problems are avoided.

In this application an air dryer means a drying device situated in a drying section of a paper machine or the like, by means of which drying device heated drying air is blown with high speed toward the surface of the web to be dried, either from one side, or preferably from both sides of the web. The air dryer comprises a heating device, by means of which the drying air is heated to a suitable temperature. The drying air may be heated to a high temperature of 200-450° C. by burning gas, or the heating device may be steam-, electricity- or oil-heated. In a steam-heated heating device the drying air is typically heated to a temperature of 130-200° C., even more typically 150-180° C. From the heating device the drying air is led into a first air supply channel, which typically extends across the web to be dried from its first edge to its second edge. From the first air supply channel the drying air is supplied into a plurality of adjacent second air supply channels, which are arranged perpendicularly to the first channel. The longitudinal axis i.e. longitudinal direction of the second air supply channels is thus parallel to the travel direction of the web to be dried and perpendicular to the transverse direction of the web. The second air supply channels lead drying air to blow nozzles, from which drying air is blown with high speed toward the web to be dried. The drying thus takes place in a contact-free manner in the air dryer.

By supplying additional air locally into the second air supply channel, the temperature of the drying air may be locally altered in a desired manner. The temperature of the additional air thus differs from the temperature of the heated drying air, the temperature of the additional air being higher or lower than the temperature of the heated drying air. The temperature difference is preferably relatively large, because then the amount of additional air may be kept small and a sufficient change may still be achieved in the temperature of the drying air to be blown toward the web. Typically the temperature difference between the additional air and the drying air is at least 20° C., preferably at least 50° C., more preferably at least 100° C., even more preferably at least 200° C., still more preferably at least 300° C., sometimes even 500° C.

Air having a temperature which is lower than the temperature of the drying air, is supplied as additional air according to one preferred embodiment of the invention. Preferably cool air is supplied as additional air into the second air supply channel, the temperature of which cool air is 10-100° C., typically 20-100° C., more typically 20-60° C., even more typically 30-50° C. Machine room air may, for example, be used as additional air, if the additional air is cooler than the drying air. Air having a temperature which is higher than the temperature of the drying air, is supplied as additional air according to another preferred embodiment of the invention. Preferably hot air is supplied as additional air into the second air supply channel, the temperature of which hot air is 200-600° C., typically 300-500° C., more typically 400-500° C. If, as additional air, it is desired to use air, having a temperature which is higher than the actual drying air, the additional air may be heated in a separate heating unit for additional air and be led from there to a desired location in the second air supply channel.

In an exemplary manner it may be stated that when the temperature of the actual drying air is about 300° C. and the temperature of the machine room air, which is used as additional air, is about 30° C., the final temperature of the air blown toward the web may be about 150° C., depending on the amount of additional air used.

Additional air may be supplied into a desired number of second air supply channels of the air dryer, preferably into each second air supply channel. Typically a drying section of a paper machine, coating machine or the like comprises several air dryers, which are arranged subsequently in the travel direction of the web. Preferably additional air is supplied into the second air supply channels of the last air dryer of the drying section, whereby the moisture profile in the transverse direction of the web may be finally optimised before the web is reeled. The drying section of the paper machine, coating machine or the like may, however, comprise one or more drying arrangements according to the invention, which may have been arranged subsequently or so that there is one or more conventional dryer units between them.

In one preferred embodiment of the invention a profiling connection is arranged in connection with a first end of the second air supply channel. Additional air is thus supplied into the second air supply channel through its first end. Additional air may be supplied into the second air supply channel solely from the first end or additional air may be supplied from the first and second end into the second air supply channel, i.e. into both ends of the second air supply channel.

The profiling connection or connections may be arranged in connection with a profiling channel, which profiling channel is arranged to supply additional air into the profiling connection/connections. Additional air is then thus led into the profiling connection or connections through the profiling channel. The profiling channel may be located in the immediate vicinity of the air dryer or at a distance from it. Typically the length of the profiling channel corresponds to the width of the web to be dried, and it is typically about 2-11 m, more typically 3-9 m, preferably 5-9 m.

Additional air is generally supplied into the profiling channel through a connection in the first end of the profiling channel. The profiling channel may be arranged to be parallel to the first direction i.e. the first air supply channel, and its cross-sectional area may decrease in the first direction, namely in the supply direction of the additional air. Thus the pressure of the additional air supplied to the profiling connections through the profiling channel may be kept relatively even over the entire length of the profiling channel. The profiling channel is preferably arranged in fixed connection with the outer surface of the air dryer. The profiling channel may for example be attached to the outer surface of the air dryer with suitable attaching members or supports.

According to one preferred embodiment of the invention the profiling connection or connections are arranged to extend a distance into the air supply channel. In this case the profiling connection may comprise an elongated pipe-like part, which is arranged to extend a distance into the second air supply channel. The profiling connection is thus arranged through the first end of the second air supply channel, and it continues as an elongated pipe-like part into the second air supply channel, typically about 50-6000 mm, more typically 1000-4000 mm, even more typically 2000-4000 mm. Typically the length of the elongated pipe-like part is at least 50%, preferably at least 70%, more preferably at least 85%, sometimes even 95% of the length of the second air supply channel. In some embodiments it is also possible that the elongated pipe-like part is substantially as long as the second air supply channel, i.e. it extends from the first end of the second air supply channel to its second end.

In another embodiment of the invention the profiling connection does not extend inside the second air supply channel, but the profiling connection is arranged in connection with the end of the second air supply channel, into which additional air is supplied. In this case the profiling connection does in practice not continue into the second air supply channel, and the length of the part of the profiling connection eventually inside the second air supply channel is thus <50 mm, more typically <30 mm, very typically 0-40 mm.

The cross-sectional shape of the elongated pipe-like part may be freely selected, usually the part has a circular or rectangular cross-section. The cross-sectional area of the pipe-like part is preferably 0.25-99.75% smaller than the cross-sectional area of the second air supply channel at the corresponding location, typically 10-90 mm, more typically 50-80 mm. The cross-sectional diameter of the pipe-like part may be constant, i.e. the diameter of the pipe-like part may be substantially the same over its entire length inside the second air supply channel. In one preferred embodiment of the invention the diameter of the elongated pipe-like part however decreases from the first end of the second air supply channel toward its second end. The diameter preferably decreases in an even and stepless manner. Preferably the cross-sectional area of the pipe-like part in the first end of the second air supply channel is substantially the same as the cross-sectional area of the second air supply channel, and the cross-sectional area of the pipe-like part decreases in an even and stepless manner toward the second end of the second air supply channel. With the pipe-like part the additional air is easily brought to a desired location of the second air supply channel.

According to one embodiment of the invention the pipe-like part of the profiling connection is perforated. Due to, the perforation the additional air may be distributed evenly inside the second air supply channel into the actual drying air, whereby a profiling result which is as even as possible is obtained. The pipe-like part may be evenly perforated over its entire length inside the second air supply channel. It is also possible that the outer surface of the pipe-like part is solid near the end part of the second air supply channel and perforated farther from the end part of the second air supply channel. In this way a profiling zone may be created at a distance from the end part of the second air supply channel. It is also possible that the density of the perforation of the pipe-like part, i.e. the distance between the perforations, and/or the size of the individual perforations varies in the longitudinal direction of the pipe-like part. In certain first locations of the pipe-like part the distance between individual perforations may be shorter than in certain second locations, whereby in the first locations the pipe-like part leads more additional air to said location in the second air supply channel. The diameter of the perforations is usually 5-100 mm.

According to one embodiment of the invention a restricting member is arranged in the profiling connection for adjusting the supply of additional air into the second air supply channel. The restricting member may, for example, comprise a regulating valve. The restricting member is preferably located outside the air dryer, so that it is not exposed to the elevated temperature prevailing inside the dryer. The restricting member may be arranged for example in the profiling connection between the profiling channel and the second air supply channel. The state of the restricting member between the “open” and “closed” states may be adjusted in a stepless manner or step by step. The adjustment of the state of the restricting member between the “open” and “closed” states may be arranged by using a servomotor or the like connected to the restricting member and controlling it. In one embodiment an individual adjustment means, such as a servomotor, may have been arranged for each restricting member, whereby the supply of additional air to each profiling connection may be controlled independently, regardless of the supply of additional air of other possible profiling connections. In this way it is possible to obtain an extremely precisely controlled moisture adjustment in the transverse direction of the web, which may also be altered according to need, for example when conditions or the quality of the paper to be dried change.

In another embodiment of the invention it is possible to group together at least two, possible several, profiling connections to a profiling connection group. The adjustment of the state of the restricting members of an individual profile connection group between the “open” and “closed” states may be arranged by using a servomotor or the like connected to each restricting member in the group and controlling them. In this manner one servomotor or the like may be used to control all restricting members of one profiling connection group. Typically profiling connections belonging to one profiling connection group are situated adjacent to each other. The air dryer may comprise one or more profiling connection groups in the transverse direction of the web. When the air dryer comprises at least two profiling connection groups, the individual profiling connection groups may have the same or a different number of individual profiling connections, i.e. the width of individual profiling connection groups in the transverse direction of the web to be dried may be the same or differ from each other. The profiling connection groups preferably comprise a different number of individual profiling connections.

The moisture content of the additional air is usually close to the moisture content of the actual drying air of the air dryer. The moisture content of the additional air is preferably not too high, i.e. it is preferably <20 g H₂O/(kg of dry air).

In one embodiment of the invention an individual second air supply channel is divided with at least one partition wall, which divides the second air supply channel in its longitudinal direction into at least two, preferably equally wide, supply modules. The width of the supply module may be 120-400 mm, preferably 140-350 mm, more preferably 150-300 mm. The second air supply channel is preferably divided into two equally wide supply modules. In one more preferred embodiment of the invention each supply module is arranged in connection with its own profiling connection, i.e. one profiling connection leads to each supply module. Furthermore the pipe-like part of a profiling connection is arranged to extend at least a distance into each supply module. Dividing the second air supply channel with a partition wall makes it possible to create relatively narrow profiling zones. The obtainable width of the profiling zone is substantially the same as the width of the supply module of the air supply channel, because when using air blows, the drying effect does not substantially spread when it is directed to the web. It is also possible that the amount of additional air supplied to the profiling connection of each supply module is restricted by its own restricting member, which may be controlled with its own servomotor or the like. The restricting members of the profiling connections of adjacent supply modules may also have been arranged to be controlled with one servomotor or the like. The partition wall may, when necessary, be installed into the second air supply channel as a retrofit in order to obtain the supply modules.

In one embodiment of the invention the arrangement further comprises measuring means for measuring the moisture profile of the moving web in the transverse direction of the web, and control means for analyzing the measurement result and for adjusting the restricting member on basis of the obtained measurement result. Thus control and correction of the moisture profile of the web to be dried may be performed as an on-line adjustment, so that the supply of additional air is based on the actual moisture profile of the web. Thus the moisture content of the moving web is measured in a transverse direction of the web, the measurement result is analyzed and the supply of additional air into the second supply channel is adjusted on basis of the obtained measurement result. The amount and/or location of the additional air to be supplied may be selected based on the obtained measurement result so that the moisture profile of the final dried web is as even as possible in the transverse direction of the web. In some embodiments the temperature of the additional air may also be selected on basis of the obtained measurement result.

Any suitable measuring device, which may be used to measure the moisture profile of the web in the transverse direction of the web, may be used as measuring means. The measuring means may, for example, be a measurement bar, which comprises a number of moisture measuring sensors or the like, and which bar is arranged to extend over the web from its first edge to its second edge. The measuring means are preferably arranged before the air dryer, which is equipped with a profiling arrangement according to the invention. The arrangement may also comprise several measuring means, for example one for each dryer unit before the profiling air dryer. It is also possible to arrange measuring means after the drying section, for example just before the reeler.

In case the measuring means are arranged before the profiling air dryer, the measurement result obtained from them is transmitted to the control means, where it is analyzed for example by calculation. At its simplest the moisture profile variation in the transverse direction of the web is given limit values, and when the limit values are exceeded in some part of the web a correction of the moisture profile of the web is performed by utilizing the method and arrangement according to the invention.

The control means thus determine from which profiling connections additional air is supplied and in what amount. The profiling connections are thus connected by using derivative coupling to the measuring and control means.

In case the measuring means are arranged after the drying section, i.e. after the profiling air dryer, the measuring means are used to measure the moisture profile of the finished web. The measurement result is transmitted to the control means, where it is analysed in a corresponding manner as described above. If it is found that the transverse moisture profile of the web differs from the defined, the profiling connections are adjusted with a signal obtained from the control means. The profiling connections are thus connected by using feedback coupling to the measuring and control means.

According to one embodiment of the invention the arrangement may comprise measuring means both before the profiling air dryer and after the profiling air dryer. Measurement values are obtained from measuring means before the profiling air dryer, based on which values the supply amount and/or location of additional air may be adjusted and controlled. Measurement values are obtained from measuring means after the profiling air dryer, based on which values the success of the moisture profiling in the transverse direction of the web may be checked, and, if necessary, the supply amount and/or location of additional air may be altered.

The method and arrangement according to the invention are suitable for use with all web widths. The width of the web to be dried may be for example 2-11 m, more typically 5-9 m.

In one embodiment of the invention the drying arrangement comprises a first and a second air dryer, which are arranged opposite each other, whereby the web to be dried is arranged to travel between them. A profiling connection has been arranged in connection with at least one, preferably several, second air supply channels of both air dryers for supplying additional air into the second air supply channel in order to change the moisture profile of the web in the transverse direction of the web. Thus the drying arrangement comprises two profiling air dryers arranged opposite each other for optimising the moisture profile of the web to be dried in the transverse direction of the web on both sides of the web.

In one embodiment of the invention the drying arrangement may be arranged in connection with an air dryer, which turns the web. In a turning air dryer the web is supported without contact and it is dried with air blows at the same time as the travel direction of the web is changed. The travel direction of the web to be dried may be changed by for example 90 degrees.

### BRIEF DESCRIPTION OF THE DRAWINGS

The invention is described in more detail below with reference to the enclosed schematic drawings.

FIG. 1 shows a part of a drying section of a paper machine, which comprises an arrangement according to one embodiment of the invention.

FIG. 2 shows an arrangement according to one embodiment of the invention seen from above.

FIG. 3 shows a cross-section of the profiling channel and profiling connections of an arrangement according to one embodiment of the invention taken along 3-3 of FIG. 2.

FIG. 4 shows a cross-section detail of an arrangement according to one embodiment of the invention taken along 4-4 of FIG. 2.

### DESCRIPTION OF THE PREFERRED EMBODIMENTS

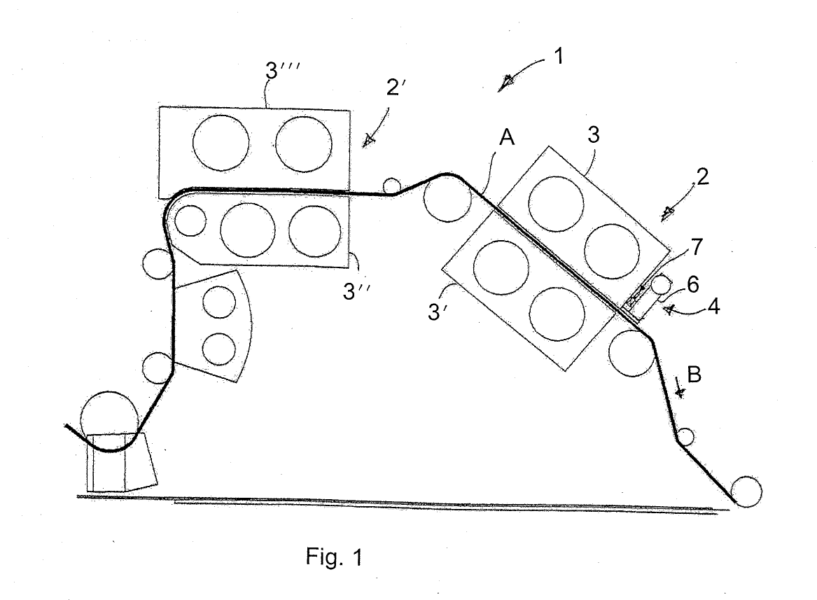

FIG. 1 shows a part of a drying section of a paper machine, which comprises an arrangement according to one embodiment of the invention. The drying section 1 comprises a first and a second dryer unit 2, 2′, having air dryers 3, 3′, 3″, 3′″ which are arranged on both sides of the web A to be dried. The web A is thus simultaneously dried from both sides. The travel direction of the web A is shown in FIG. 1 with an arrow B. In connection with the first air dryer 3 of the last dryer unit 2 in the travel direction B of the web A has been arranged an arrangement 4 according to the invention for supplying additional air into the second air supply channel of the air dryer 3 in order to alter the moisture profile of the web in the transverse direction of the web. The arrangement comprises a profiling channel 6 and a profiling connection 7, which connects the profiling channel 6 to the air dryer 3.

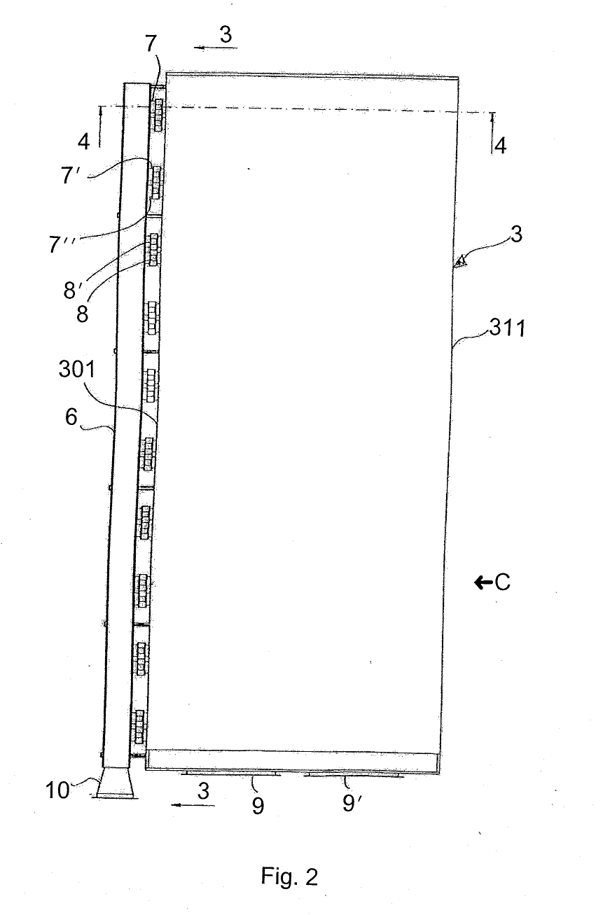

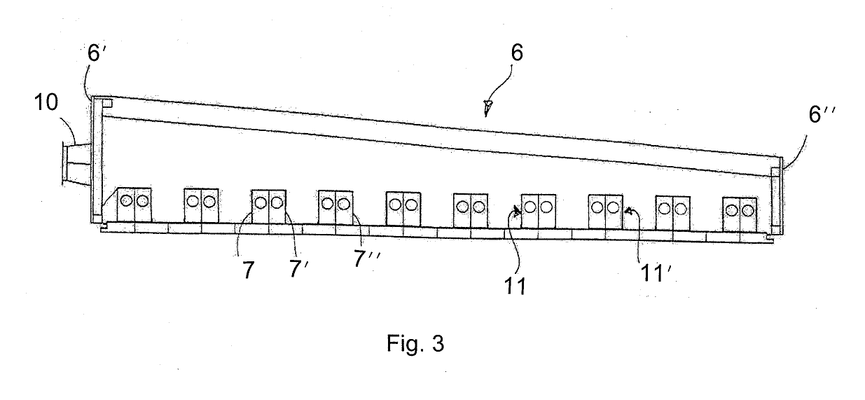

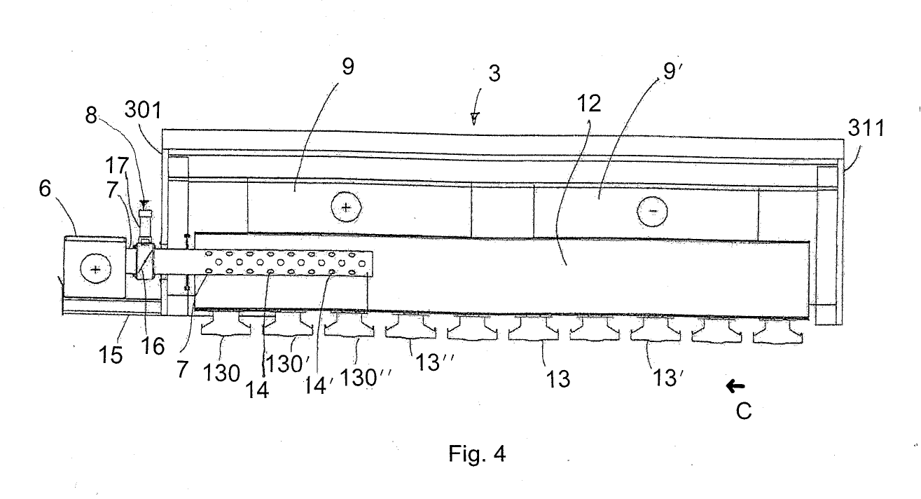

FIG. 2 shows an arrangement according to one embodiment of the invention seen from above. A profiling channel 6 has been arranged in connection with the first end 301 of the air dryer 3. The profiling channel 6 is connected to the air dryer 3 via several adjacently arranged profiling connections 7, 7′, 7″. Additional air is supplied into the profiling channel 6 through a connection 10 arranged in the first end, the temperature of which additional air differs from the temperature of the drying air supplied into the air dryer 3. From the profiling channel 6 the additional air is led with the aid of the profiling connections 7, 7′, 7″ to the second supply channels 12 (shown in FIG. 4) of the air dryer 3. The second supply channels 12 are arranged inside the air dryer 3, to extend in the travel direction C of the web from the first end part 301 of the air dryer to its second end part 311. The amount of supplied additional air may be controlled and managed by means of restricting members 8, 8′ arranged in the profiling connections 7, 7′, 7″. FIG. 3 also shows the first air supply channel 9 of the air dryer and a first air removal channel 9′, which is adjacent and parallel to it. The travel direction of the web is illustrated with an arrow C.

FIG. 3 shows a profiling channel and profiling connections of an arrangement according to one embodiment of the invention. The profiling channel 6 is arranged to have an evenly decreasing cross-sectional area, i.e. the cross-sectional area of the first end 6′ of the profiling channel 6 is larger than the cross-sectional area of the second end 6″ of the profiling channel 6. When additional air is supplied into the evenly narrowing profiling channel 6, the pressure of the air supplied into the profiling connections 7, 7′, 7″ remains constant or nearly constant over the length of the entire profiling channel. A number of profiling connections 7, 7′, 7″ has thus been arranged on the side of the profiling channel 6. The profiling connections 7, 7′, 7″ have been arranged in pairs and with even intervals over the entire length of the profiling channel 6. The profiling connections of one profiling connection pair 11, 11′ lead additional air into the parallel supply modules of one second air supply channel 12 as seen in FIG. 4. The parallel supply modules of the second air supply channel 12 are formed by dividing the first air supply channel 9 for example with a partition wall.

FIG. 4 shows a detail of an arrangement according to one embodiment of the invention. A profiling channel 6 has been arranged in connection with the first end part 301 of the air dryer 3. The profiling channel 6 may be supported on the air dryer 3 for example with supports 15. A profiling connection 7 leads from the profiling channel 6 to the air dryer to its first end part 301, and through the first end part 301 to the second air supply channel 12. The part of the profiling connection 7, which extends into the second air supply channel 12, is at least partly perforated, i.e. holes 14, 14′ have been arranged therein for supplying additional air into the second air supply channel 12.

The second air supply channel 12 extends from the first end part 301 of the air dryer 3 to its second end part 311, according to the travel direction C of the web. Air is supplied into the second air supply channel from the first air supply channel 9, which extends in the transverse direction of the web. From the second air supply channel 12 drying air is supplied to blow members 13, 13′, 13″, each of which is arranged in connection with several second air supply channels 12. From FIG. 4 may be seen that in the case illustrated by the figure additional air is supplied by means of a profiling connection 7 into the second air supply channel 12, so that the additional air only affects the drying air supplied from some of the blow members 130, 130′, 130″. A profiling area is thus formed at these blow members 130, 130′, 130″.

The amount of additional air to be supplied into the profiling connection 7 may be controlled by means of a restricting member 8. The restricting member 8 may for example comprise a valve member 16 or the like, by means of which the amount of additional air flowing into the profiling connection is regulated. The valve member 16 may be controlled by means of an adjustment means 17 arranged in connection thereto, such as a servomotor.

The air dryer 3 also comprises an air removal channel 9′ adjacent and parallel to the first air supply channel 9, by means of which moist air is removed by sucking between the blow members 13, 13′, 13″. The travel direction of the web is in FIG. 4 illustrated with an arrow C.

The embodiment examples and advantages mentioned above relate, as applicable, to both the method and the arrangement according to the invention, even if this is not always specifically stated.

The invention is not meant to be limited to the embodiments shown as examples above, but the aim is to interpret it extensively within the scope of protection defined by the claims presented hereafter.

We claim:

1. A drying arrangement for a moving paper or board web defined between a first edge and a second edge, the moving web defining a first direction in which the web moves and a transverse direction across the web and between the first edge and the second edge, the arrangement comprising:
an air dryer, which comprises:
a first air supply channel which extends in the transverse direction of the moving web from the first edge toward the second edge;
a plurality of second air supply channels which are arranged in connection with the first air supply channel, and into which heated drying air is supplied from the first air supply channel, the second air supply channels extending along the web in the first direction, which is perpendicular to the transverse direction;
elongated blowing members, each of which is arranged in connection with a plurality of the second air supply channels for supplying heated drying air from the second air supply channels to the blowing members, the blowing members being parallel to the first air supply channel;
wherein at least one profiling connection is arranged in connection with at least one of the second air supply channels for supplying additional air into the at least one second air supply channel in order to change a moisture profile of the web in the transverse direction of the web.

2. The drying arrangement of claim 1 wherein the profiling connection is arranged in connection with a first end of the second air supply channel.

3. The drying arrangement of claim 1 wherein the profiling connection(s) are arranged in connection with a profiling channel, which profiling channel is arranged to supply additional air to the profiling connection(s).

4. The drying arrangement of claim 3 wherein the profiling channel is arranged to be parallel to the first air supply channel, and wherein the profiling channel has a cross-sectional area which decreases in the transverse direction.

5. The drying arrangement of claim 1 wherein the profiling connection comprises a pipe-like part, which is arranged to extend a distance into the second air supply channel.

6. The drying arrangement of claim 5 wherein the pipe-like part of the profiling connection has portions defining perforations.

7. The drying arrangement of claim 1 wherein a restricting member is arranged in the profiling connection for adjusting the supply of additional air.

8. The drying arrangement of claim 1 wherein the restricting member is a regulating valve.

9. The drying arrangement of claim 7 further comprising a moisture measuring sensor arranged to measure the moisture profile of the moving web in the transverse direction of the web, and control means for analyzing the measurement result and for adjusting the restricting member on the basis of the obtained measurement result.

10. A method for drying a moving paper or board web defined between a first edge and a second edge, the moving web defining a first direction in which the web moves and a transverse direction across the web and between the first edge and the second edge, the method comprising the steps of:
supplying heated drying air into a first air supply channel which extends in the transverse direction of the web from the first edge toward the second edge;
leading heated air from the first air supply channel into a plurality of second air supply channels which are arranged in connection with the first air supply channel, wherein the second air supply channels extend in the first direction;
leading heated air from the second air supply channels into elongated blowing members, each of which is arranged in connection with a plurality of second air supply channels, the elongated blowing members being parallel to the first air supply channel; and
supplying additional air into at least one of the second air supply channels through a profiling connection(s) to change a moisture profile of the moving web in the transverse direction of the moving web.

11. The method of claim 10 wherein the step of supplying additional air employs additional air which is lower in temperature than the drying air.

12. The method of claim 11 wherein the step of supplying additional air employs additional air at a temperature of 10-100° C.

13. The method of claim 10 wherein the step of supplying additional air includes supplying additional air into a first end of the second air supply channel.

14. The method of claim 10 further comprising the step of leading additional air into the profiling connection(s) through a profiling channel.

15. The method of claim 10 wherein the profiling connection(s) are arranged so as to extend a distance into the air supply channel and to so deliver the additional air the distance into the air supply channel.

16. The method of claim 10 further comprising adjusting the supply of additional air to the second supply channel with a restricting member arranged in the profiling connection.

17. The method of claim 16, further comprising measuring a moisture profile of the moving web in a transverse direction of the web, analyzing the measurement result, and adjusting the supply of additional air into the second supply channel on the basis of the obtained measurement result.
